(19) United States
(12) Patent Application Publication
(10) Pub. No.: US 2007/0061312 A1
(43) Pub. Date: Mar. 15, 2007

(54) Computer search engine and method for retrieving information

(75) Inventors: Maxwell S. Matthews, Birmingham, MI (US); Christopher Falberg, Waterford, MI (US)

Correspondence Address: THE WEINTRAUB GROUP, P.L.C., 32000 NORTHWESTERN HIGHWAY, SUITE 240, FARMINGTON HILLS, MI, 48334, US

(73) Assignee: Matthews Software, Inc.

(21) Appl. No.: 11/513,736

(22) Filed: Aug. 31, 2006

Related U.S. Application Data
(60) Provisional application No. 60/713,153, filed on Aug. 31, 2005.

(51) Int. Cl. G06F 17/30

(52) U.S. Cl. 707/3

(57) ABSTRACT

A system and method for extracting data from a database includes populating a database with information that includes not only identifying the item but defining at least one specification for that entity or item and storing it in a table that correlates to the entity containing the defined specifications. An entity or item can have more than one specification type to facilitate different types of searches. The system includes a select module for executing at least one procedure, the procedure containing instructions for identifying the data based upon at least one search parameter received by the procedure. The system also includes parameter module which receives a user selected search parameter for further identifying data from the select module. An extraction module executes a request to retrieve the identified data from the database.

### CROSS REFERENCE TO RELATED APPLICATIONS

This application is a completion application of co-pending U.S. Provisional Patent Application Ser. No. 60/713,153 for “Computer Search Engine and Method for Retrieving Information” filed Aug. 31, 2005, the entire disclosure which is hereby incorporated by reference.

### BACKGROUND OF THE INVENTION

1. Field of the Invention

The present invention relates to an electronic system for storing, searching and extracting data from a database.

2. Prior Art

The computer search engine has become an invaluable tool for retrieving information from a database. A database is the structure a software application uses to contain and organize information. A database may store information such as data, music, video, images and text. The software used to manage and query a database is known as a database management system. Typically the information stored in a database is organized into fields. The information may be structured in a database in a number of ways, such as by a hierarchical model, where a fact is associated with each piece of data, or a relational model, where the data satisfies a logical predicate.

In the field of search engines, popularized by the Internet, a number of complex algorithms are developed to arrive at search results. An Internet search engine will send out small code fragments, commonly referred to as spiders, to search and identify web pages throughout the Internet. Information such as the web page location and key words are documented and arranged in a database. When a user enters key words, the database retrieves the search results based upon the search engine's search algorithm.

However, it is common to receive inapplicable search results. Much time is spent sorting through results to find the desired information.

Thus, it is desirable to provide a computer program or system for extracting data from a database that eliminates inapplicable search results. Additionally, it is further desirable to provide a computer program that can efficiently narrow search results by adding additional search parameters.

### SUMMARY OF THE INVENTION

In a first aspect, the present invention provides a method for storing, searching and extracting data from a database comprises a select module for executing at least one procedure, where the procedure contains instructions for identifying data. Additionally, the procedure may receive at least one search parameter. The system further includes a parameter module which receives at least one user selected search parameter to further identify data from the select module. An extraction module executes a request to retrieve the identified data from the database.

The procedure executed by the select module may identify data from specified data fields within specified tables within a database. Additionally, the procedure executed by the select module may be based on a search type selected by a user. The procedure may identify data by specifying data fields from specified tables. Finally, the select module may identify data by specifying data fields from specified tables with a specified parameter.

The present invention, also, includes a method of extracting data from a database which comprises the steps of: (a) selecting a search type and (b) executing a procedure as a result of a search type to identify an initial set of data within which to search. According to the method, a user selects at least one parameter to further identify data within the initial set of data. The identified data is retrieved from the database from within the initial set of data. Additionally, a user may select an additional parameter to still further identify data and retrieve the identified data.

In another aspect hereof, there is provided a method for populating a database comprising the steps of: (a) identifying an entity or item and (b) defining at least one specification type for that entity or item. The specification(s) associated with each specification type are identified. A table is, then, created that contains the defined specifications for the identified item or an entity. One entity or item may have more than one specification type to facilitate different types of searches.

Further objects, features and advantages of the present invention will become apparent to those skilled in the art from analysis of the following written description and, the accompanying drawings.

### BRIEF DESCRIPTION OF THE DRAWINGS

FIG. 1 is a simplified architectural block diagram of an embodiment of the computer program of the present invention;

FIG. 2 is a simplified process flow diagram illustrating the computer program in accordance with the principles of the present invention;

FIG. 3 is a simplified process flow diagram illustrating the method of populating tables in the database in accordance with the principles of the present invention;

FIG. 4 is a diagram of an exemplary table relationship in accordance with the principles of the present invention;

FIG. 5a is a flow chart of generic procedures that may be associated with an entity;

FIG. 5b is a relationship chart of procedures that may be associated with an entity based on a selected search type;

FIG. 5c is another relationship chart of procedures that may be associated with a different entity based on a selected search type; and

FIG. 6 is an exemplary graphic user interface in accordance with the principles of the present invention.

### DESCRIPTION OF THE PREFERRED EMBODIMENT

The present invention is illustrated as being implemented in a suitable computing environment. Although not required, the invention will be described in the general context of executable instructions, such as program modules, being executed by one or more computers. Generally, program modules may include code segments, processes, scripts, routines, programs, objects, components, data structures, etc. that perform particular tasks or processes. Those skilled in the art will appreciate that the invention may be practiced with a variety of computer systems, including in distributed computing environments where tasks are performed by remote processing devices that are linked through a communications network. In a distributed computing environment, program modules may be located in both local and remote memory storage devices.

An exemplary computer system for implementing the invention includes a general purpose computing device in the form of a server, including a processor, memory, and a bus device that couples various components including the memory to the processor. The bus may be any of several types of bus structures including a memory bus or memory controller, a peripheral bus, and a local bus using any of a variety of bus architectures. The memory includes read only memory (ROM) and random access memory (RAM). The computer may include a hard disk-drive for reading from and writing to a hard disk, a magnetic disk drive for reading from or writing to a removable magnetic media, an optical disk for reading from or writing to a removable optical media, such as a CD ROM, or other optical media. A monitor or other type of display device is also connected to the system via an interface, such as a video adapter.

A hard disk drive, magnetic disk drive, and/or optical disk drive may be connected to a bus by an interface. The drives and their associated computer-readable media provide non-volatile storage of computer readable instructions, data structures, program modules and other data for the computer. Although the exemplary environment described herein employs a hard disk, it will be appreciated by those skilled in the art that other types of computer readable media which can store data that is accessible by a computer may also be used in the exemplary operating environment.

A number of program modules may be stored on the hard disk, magnetic disk, optical disk, ROM or RAM, including an operating system, one or more applications programs, other program modules, and program data. Additionally, one or more database programs are installed on a computer readable media.

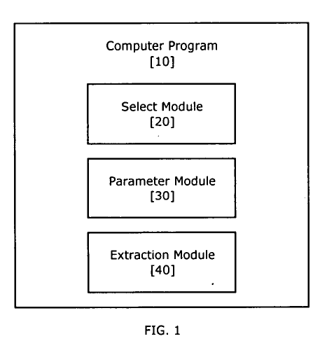

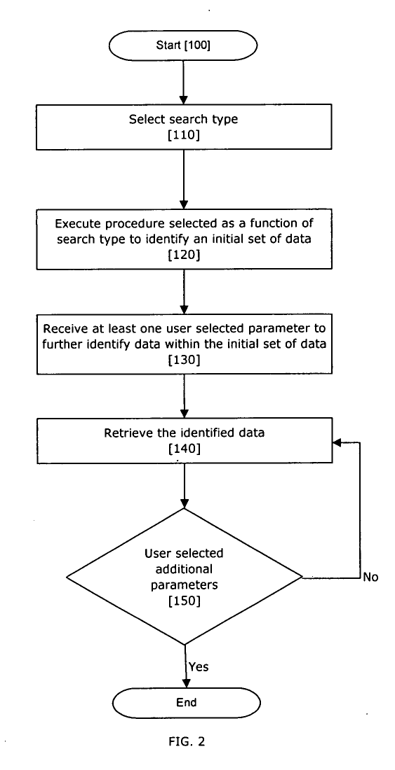

With initial reference to FIGS. 1 and 2, there is shown an embodiment of the system 10 of the present invention. The system 10 contains instructions to complete tasks set forth herein as modules. The system 10 of the exemplary embodiment set forth herein is illustrated as a system for identifying automotive parts; however, the specific embodiment is not intended to limit the application in any way. In fact, the system 10 may be applied to search for any type of data desired.

System 10 comprises a select module 20, a parameter module 30 and an extraction module 40. FIG. 2, depicts the process 100 for the system 10 in accordance with the principles of the present invention. As shown, the process begins by selecting a search type 110. The select module 20 executes a procedure 120 containing instructions for identifying an initial set of data. A plurality of procedures may be available for each search type. Once a user has selected a search type, the select module 20 identifies the procedure to execute.

The procedure, itself, is a set of instructions that identifies data based on information located in a data source. The data source provides information as to where to initially locate the data to be identified and the type of data to be initially located. In the preferred embodiment, the data source is a table located within a database. However, the data source may be a table located outside of a database and, thus, may be a file or any other data source that is known or becomes known in the art.

The procedure 120 receives at least one search parameter, for example, in an automotive environment, “air cleaner”, whereby an initial set of data may be queried in the data source as a function of that parameter. The system 10, as described herein, is described using user-based terminology on the user side and system-based terminology on the system side. A parameter is used to describe a user input; however a specification is used to describe a system query. For example, a parameter may be auto “air cleaner” as a user input and a specification as a system query. An entity or item will be described in terms of a specification type and specification. For example, a specific air cleaner may be defined by a specification type, i.e. “part type” and specification “air cleaner”. In the preferred embodiment, the system is operated within an SQL, or structured query language. However, it should be understood that the present environment may operate in a number of environments.

The parameter module 30 receives at least one user selected search parameter to further identify the initial data 130 identified by the select module 20. At this point a user searching for air cleaners, for example, may be interested in locating a “chrome air cleaner”. As such, a user may select “chrome” as a parameter.

The extraction module 40 executes a request or query to retrieve data 140 identified by the parameter module 30. A user may input multiple parameters in the parameter module 30 and then execute the extraction module 40 or may choose to narrow search results by selecting additional parameters 150 and then retrieving the identified data 140.

In extracting the data, the user can select any well-known method or procedure known to the skilled artisan. One particularly preferred method of extraction or for retrieving data is that disclosed in co-pending U.S. patent application Ser. No. 11/491,706, filed on Jul. 24, 2006 for “Computer Program and Method for Retrieving Information from a Database”, which is a completion application of U.S. Provisional Patent Application Ser. No. 60/702,075 dated Jul. 22, 2005 the entire disclosures which are hereby incorporated by reference.

In the preferred embodiment, the procedure of select module 20 identifies data from specified fields and specified tables found in the database. In the preferred embodiment, the procedure may identify data by specifying data fields from specified tables. Additionally the procedure may select data by specifying fields from specified tables that query a specified parameter. The procedure obtains the information from a lookup table or from a specification table. The specification tables are created based on a specific entity and for a specific search.

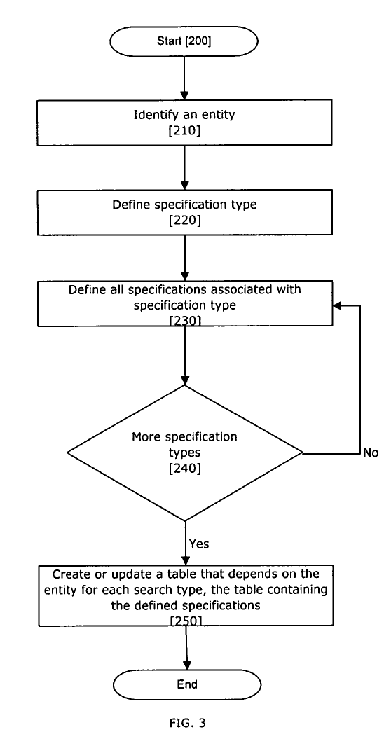

Referring now also to FIG. 3, a process flow diagram is shown illustrating the method of populating tables for each item in the database in accordance with the principles of the present invention. The process 200 begins by identifying a specific entity or item 5, for example, a specific air cleaner at step 210. A specification type is then defined at 220, for example, the finish. Then all specifications for a specification type are defined at 230. This is continued until all specification types for a specific entity are defined at 240. Lastly the table is created or updated for a pre-existing table, and populated at 250.

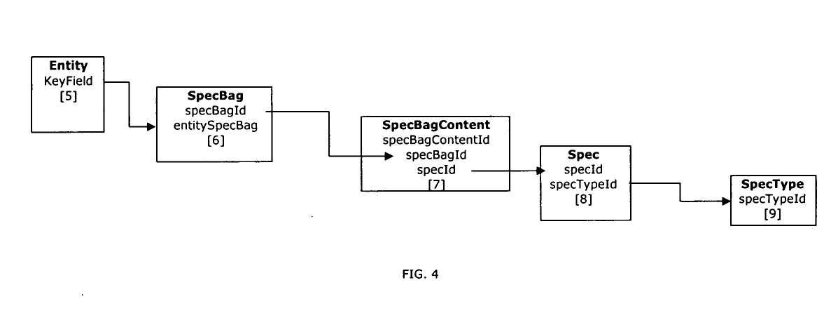

Referring now also to FIG. 4, a diagram of an exemplary table relationship is shown in accordance with the principles of the present invention. The following describes the relationship between the tables created in step 250 of FIG. 3. Each specification table 6 and procedure is related to only one entity 5. An identifier, such as partKeyField, creates a relationship between the tables. Table 7 has a line item that corresponds to the specification table 6. Each parameter, or as referred to in the table structure, specification 8, for example, “chrome”, that relates to an entity 5 is identified in the specification table 7. A specification type table 9 identifies the type of specification, for example, finish.

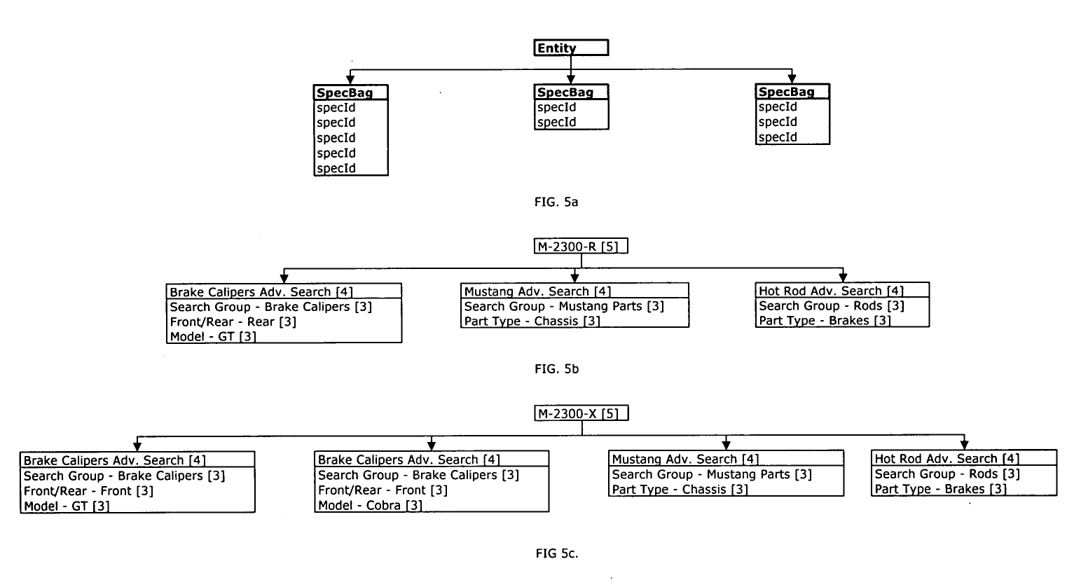

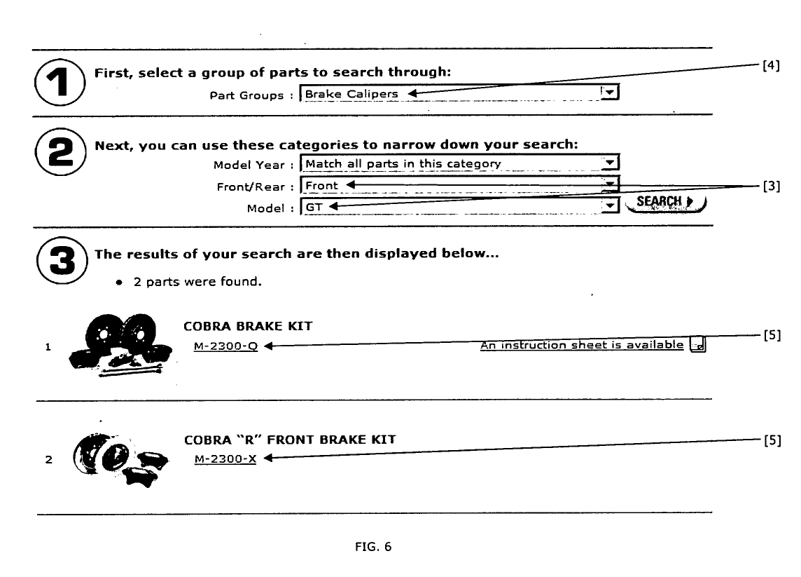

FIGS. 5a through 5c, set forth relationship charts showing the relationship of a search to a procedure as described in the process 100 of FIG. 2. Each procedure 3 is associated with an entity 5 based on a selected search type 4. For example, a part number, i.e. M-2300-R, as shown in FIG. 5b, is associated with three different search types 4. Each search type 4 is related to a procedure 3. As a result, each procedure 3 identifies an initial set of data which may be further defined by the user.

A parameter 2, here, “air cleaner”, is a search parameter associated with the select module 20 as a default parameter. The select module 20 will include the parameter “air cleaner” to initially identify data. As a result, all available air cleaners are initially identified. In the parameter module 30, the user has selected parameters “chrome” and “Ford Racing”. These parameters are referred to as specifications 8 in the system query, as finish and logo are referred to as specification types 9. Upon pressing the “search” button, the extraction module 40 retrieves the identified data by running a query within the database which meets the input received by parameter module 30 and data identified by selection module 20.

In another example of the implementation of the present invention, it is assumed that the item or entity is a restaurant. The initial step in the process comprises defining the characteristics of a restaurant including, for example, its name, the type of food it serves; its hours of operations; its location, its pricing, etc. These parameters are then stored in a database and identified as a specification(s) for a restaurant. Once the item has been identified then the specifications are entered into the database for that restaurant. A table is then created in the database for these specifications. As more restaurants are identified, then, additional specifications are created and placed in the database and additional tables are created therefrom. To search a user will enter his or her desired parameters into a search request to search the database for restaurants having the selected characteristics. Specifically, if one were looking for an all night eatery, in Washington, D.C., the database would be searched and the results based upon those parameters would be provided.

Thus, the initial step in the process of the present invention is to consider and identify each item and define its characteristics. Thereafter, the second step is to tag each item by which characteristics it matches.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention.

1. A system for extracting data from a database, comprising:
(a) a database;
(b) select module for executing at least one procedure, the at least one procedure comprising instructions for identifying data;
(c) a parameter module comprising means for receiving at least one user selected search parameter, the means for receiving further identifying data from the select module, and
(d) an extraction module for retrieving the identified data from the database.

2. The system of claim 1 wherein the database comprises:
data fields contained within specified tables.

3. The system of claim 1 wherein the select module comprises:
means for identifying data from specified data field within specified tables.

4. The system of claim 3 wherein the select module further comprises:
means for executing the at least one procedure responsive to a user selected search.

5. A method for extracting data from a database which comprises:
(a) providing a database;
(b) selecting a search type; and
(c) executing a procedure pursuant to the selected search type, the procedure identifying an initial set of data in which to search;

6. The method of claim 5 which further comprises:
(a) selecting at least one parameter to further identify data within the initial set of data.

7. The method of claim 5 which further comprises:
retrieving the data within the initial set of data.

8. The method of claim 7 which further comprises:
selecting an additional parameter to further identify data for refining the data retrieved within the initial set of data.

9. A method for populating a database, comprising:
(a) identifying at least one item,
(b) defining at least one specification for that entity,
(c) associating the specification with the item, and
(d) creating a table for the item with the associated specification, and
(e) storing the table in a database.

10. The method of claim 9 which further comprises:
identifying a plurality of items, and
identifying a plurality of specifications for the plurality of items.

11. The method of claim 9 which further comprises:
identifying a plurality of specifications for the item, and
storing the plurality of specifications within the table.
